(19) United States
(12) Patent Application Publication
(10) Pub. No.: US 2022/0086034 A1
(43) Pub. Date: Mar. 17, 2022

(54) OVER THE TOP NETWORKING MONITORING SYSTEM

(71) Applicant: ARRIS Enterprises LLC, Suwanee, GA (US)

(72) Inventor: Niranjan H. KOLHEKAR, Bangalore (IN)

(21) Appl. No.: 17/404,818

(22) Filed: Aug. 17, 2021

Related U.S. Application Data
(60) Provisional application No. 63/079,266, filed on Sep. 16, 2020.

(51) Int. Cl. H04L 12/24

(52) U.S. Cl. CPC H04L 41/069; H04L 41/0654

(57) ABSTRACT

A system for managing network devices of a communications network that includes a management system receiving log information and fault information. Based upon the log and fault information, the management system attempts to mitigate the fault using a machine learning process.

### CROSS-REFERENCE TO RELATED APPLICATIONS

This application claims the benefit of U.S. Provisional Patent Application Ser. No. 63/079,266 filed Sep. 16, 2020.

### BACKGROUND OF THE INVENTION

A network management systems can be associated with communication networks, with the purpose of collecting alarms from network equipment, forming a summary of the collected alarms, particularly using correlation methods, and displaying this alarm summary to an operator so that the operator can implement corrective action in the case of a failure of the network equipment. The concept of a “failure” or “fault” is understood to be a very general term for any type of hardware and/or software malfunction. Network equipment and/or software that is no longer operational in some manner is considered to have a failure. Likewise, an improper configuration of network equipment and/or software is considered to have a failure.

Network management systems can be used to configure network equipment. The operator can input new parameters using a man-machine interface and the network management system applies these new parameters to the network equipment. In this way, the operator can correct a network failure in reaction to an alarm.

Such a centralized analysis depends on collection of a large amount of data and alarms from many elements in the communication system. These elements may be network equipment, such as for example, routers, switches, computer servers, networking cards and other components of computer servers, inclusive of software.

Due to the many interactions between network elements, a single failure can generate a substantial number of alarms. Thus, a failure on a router may generate an alarm from other network equipment connected to one of the ports on the router. It is therefore difficult for the operator to determine which is the genuine failure among the large number of generated alarms, and even more so to determine the corrective action to be undertaken.

Nevertheless, the operator has to take action with each failure to determine the corrective action(s) to be undertaken and to undertake the corrective action(s). The operator then needs to reconfigure the network equipment using the network management system or to manually connect to one or more of the network equipment and send the appropriate CLI (command line interface) commands.

The foregoing and other objectives, features, and advantages of the invention may be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a communication network.

FIG. 2 illustrates a list of network devices.

FIG. 3 illustrates a list of network devices.

FIG. 4 illustrates a management system.

FIG. 5 illustrates a log file.

FIG. 6 illustrates an e-mail notification.

FIG. 7 illustrates a fault based query.

FIG. 8 illustrates a fault based query.

FIG. 9 illustrates a fault based query.

FIG. 10 illustrates a fault based query.

FIG. 11 illustrates a fault mitigation process.

### DETAILED DESCRIPTION OF PREFERRED EMBODIMENT

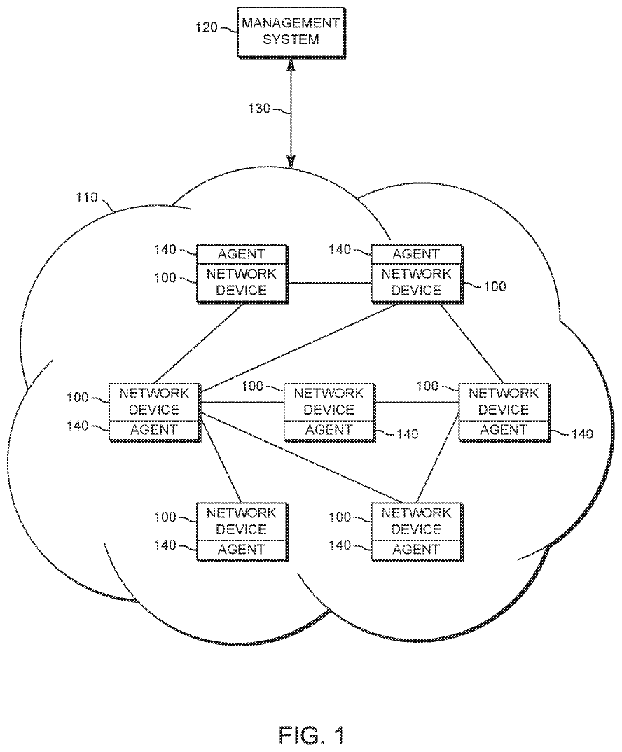

Referring to FIG. 1, a communication network 110 may include one or more network devices 100. The network devices may be any suitable type of device, such as for example, cable modems, routers, switches, servers, workstations, printers, bridges, hubs, IP telephones, IP video cameras, computer servers, and software applications. Each of the network devices 100 may include any type of hardware device and/or software that is interconnected to a network, such as within a communication network 110. Each of the network devices 100 may be interconnected to any other type of hardware device and/or software, such as within the communication network 110. Each of the network devices 100 may be interconnected with a management system 120, such as using a network connection 130.

The network devices 100 and the management system 120 may be interconnected with one another using any protocol. For example, a simple network management protocol (SNMP) may be used for collecting and organizing information about managed devices and software on an Internet protocol network and for modifying that information to change the network device and/or software behavior. SNMP may be used to expose management data in the form of variables on devices and/or software to be managed. Normally, SNMP enables the variables to be remotely queried, and often manipulated, by the management system 120. Each of the network devices 100 includes a respective agent 140 which reports information via SNMP to the management system 120. The agent 140 may permit unidirectional (read-only) or bidirectional (read and write) access to network device specific information. The agent 140 is a network management software module that resides on the respective network device and has local knowledge of the management information and translates that information to and/or from a SNMP specific form. The information from the respective agent 140 may be polled and/or pushed to the management system 120. In this manner, the management system 120 receives information from each of the respective agents 140, either on a regular basis or in response to a request. The agents 140 may further provide alerts to the management system 120 of a failure of the corresponding network device and/or software 100.

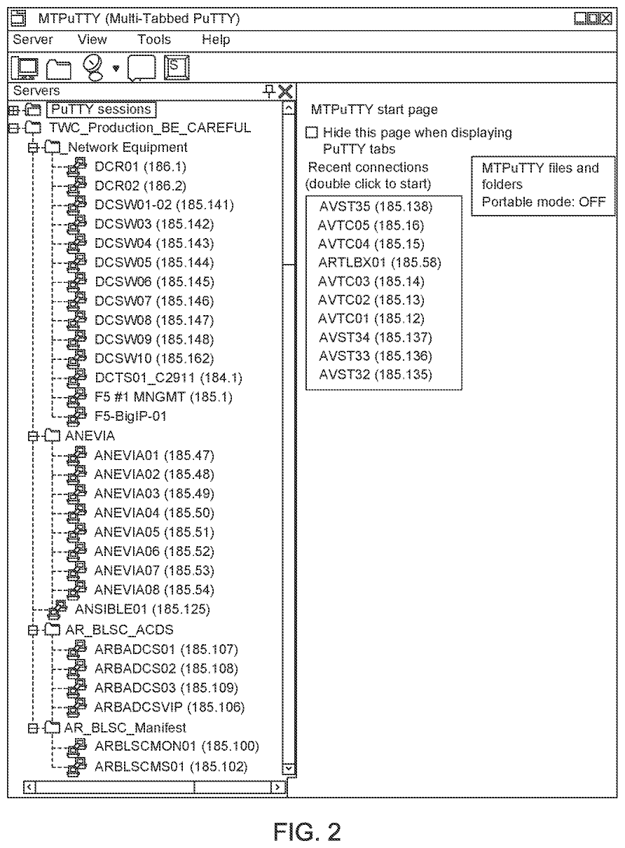

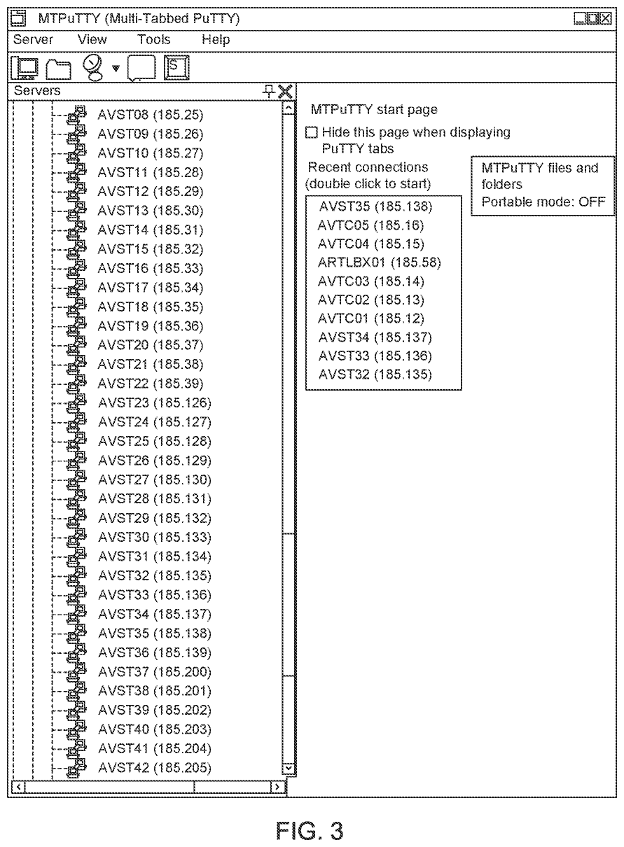

Referring to FIG. 2 and FIG. 3, the management system 120 may include a hierarchical list of network devices, such as organized by device name and a corresponding network address identification. An operator may examine each of the network devices, which may be within different directory structures, to determine the characteristics of each of the network devices as provided from the corresponding agent. For a relatively complicated set of network devices there may over 100 lists of network devices, with a substantial number of network devices (e.g., computer servers) listed within each list. In the event of a fault, it can be problematic to identify the network device with the error within the multitude of lists and devices therein. To simplify the identification of network devices that have an identified fault, an additional software program may be used to graphically illustrate which devices have a fault, such as a red indication of a fault or a green indication of no fault. While the identification of a fault may be identified from the list of devices, or the graphical illustration, it is problematic to determine an appropriate action to mitigate the issue.

For example, a router card may experience a failure. The management system 120 may receive a fault notification together with additional information from a corresponding agent 140 for the router card. Based upon the additional information a support engineer may attempt to diagnose the source of the fault notification. Initially, the support engineer may determine it is desirable to initiate a rebooting of the router card to attempt to remedy the fault condition. If the router card, as a result of rebooting the router card, operates properly then the corrective action was successful.

For example, a manifest delivery controller is a software application running on a computer server for modifying video manifests to enable server-side dynamic advertisement insertion, content personalization, and analytics for Internet protocol based video. The management system 120 may receive a fault notification together with additional information from a corresponding agent 140 for the manifest delivery controller that has failed. Based upon the additional information a support engineer may attempt to diagnose the source of the fault notification. Initially, the support engineer may determine it is desirable to initiate a rebooting of the manifest delivery controller to attempt to remedy the fault condition. If the manifest delivery controller, as a result of rebooting the manifest delivery controller, fails to operate properly then the support engineer needs to further examine the logs to attempt to determine an appropriate course of action. Unfortunately, it can be rather time consuming to determine an appropriate course of action.

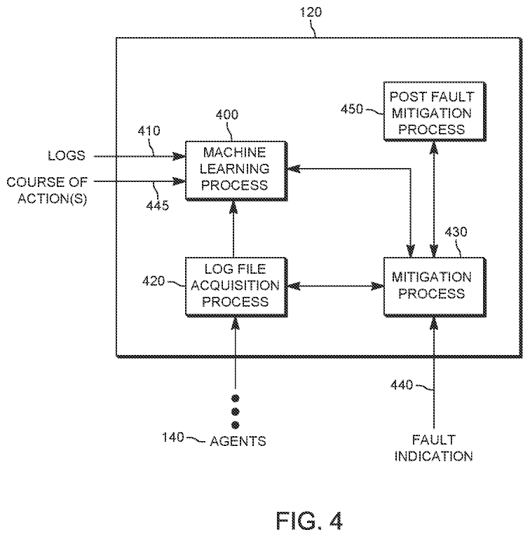

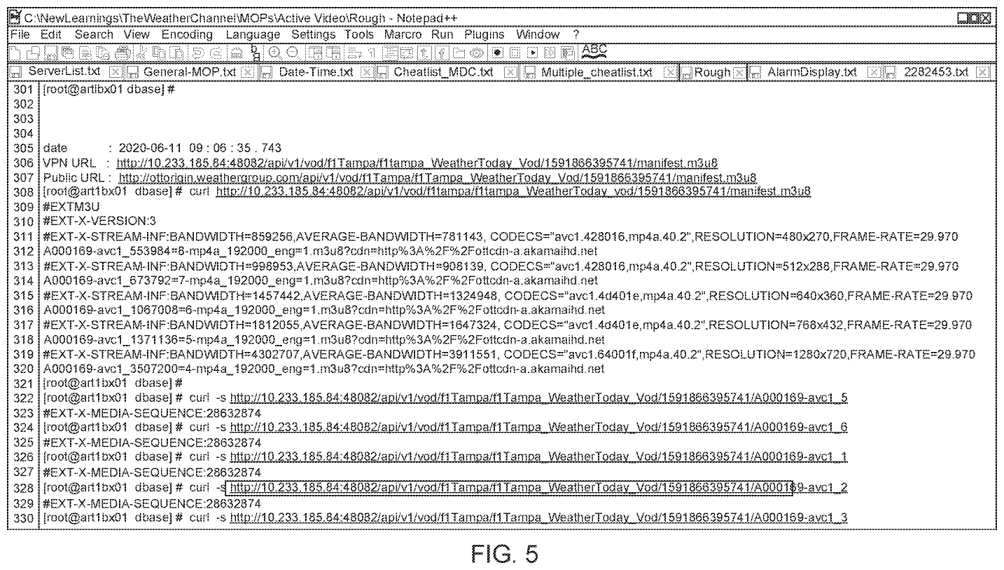

Referring to FIG. 4, the management system 120 may include a machine learning process 400 that builds a model based upon sample data, generally referred to as training data, in order to make decisions without having to be explicitly programmed to do so. Any machine learning technique may be used, including for example, supervised learning, unsupervised learning, reinforcement learning, topic modeling, dimensionality reduction, deep learning, and meta learning. The training data may include logs 410, such as an exemplary log illustrated in FIG. 5, from each of the respective network devices 100 together with a course of action 415 that was used to repair the fault and/or course of actions that did not result in repair of the fault, each of which may include one or more actions. With a sufficiently large set of training data that includes the course of actions that were successful and/or unsuccessful, the machine learning process 400 may have a trained state.

The management system 120 may include a log file acquisition process 420 that retrieves the log files from the corresponding network devices 100 upon a fault being detected, or otherwise periodically receives and updates the log files from the network devices 100 on a continual basis. In this manner, when a fault is triggered for one or more network devices 100 by a corresponding one or more agents 140, the log files have already been received by the log file acquisition process 420 or otherwise received by the log file acquisition process 420 in response to receiving one or more faults. A mitigation process 430 receives the fault indication 440 and, based upon the corresponding log files from the log file acquisition module 420, processes the log files using the trained machine learning process 400. In response, the mitigation process 430 suggests an appropriate manner of mitigating the fault. Based upon any suitable criteria, the mitigation process 430 may automatically perform the determined one or more mitigation activities. If as a result of the automatic mitigation activities, such as restarting the device and/or software process, or reinstalling and/or reconfiguring the device and/or software process, the fault remains then the fault may be elevated to an appropriate support engineer with supporting documentation regarding the fault, including appropriate suggestions from the machine learning process 400 based upon previous encounters with the same or similar faults.

The support engineer may go through the log files that have been retrieved by the log file acquisition process 420, together with examination of additional data remaining on the network devices 100, if desired, to make an analysis of what is the likely root cause for the fault.

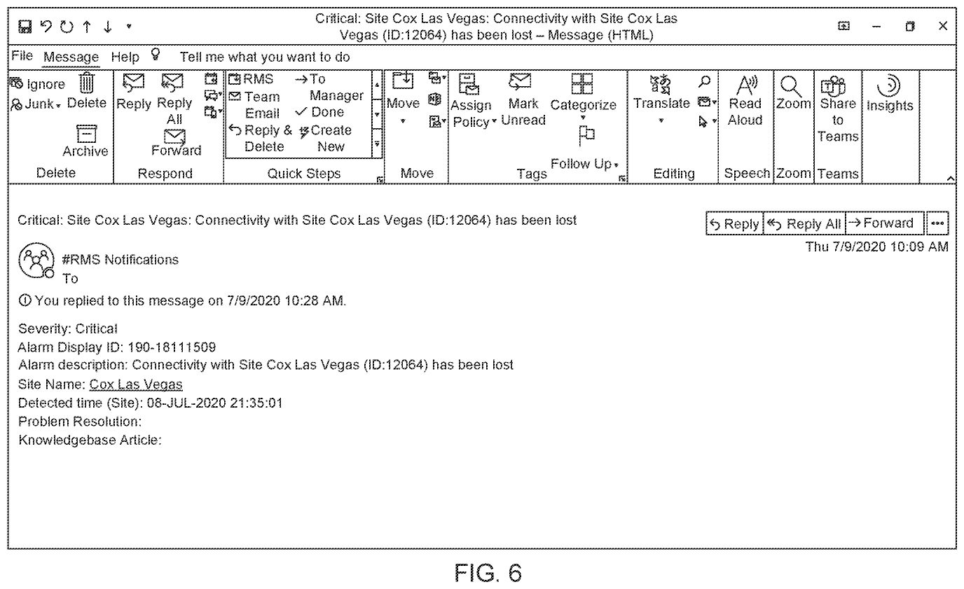

Referring to FIG. 6, by way of example, the management system 120 may receive e-mail alerts of faults, such as each time a network device loses network connectivity. If desired, the e-mail alerts that identify faults may be processed by the mitigation process 430 to attempt an automated mitigation of the fault.

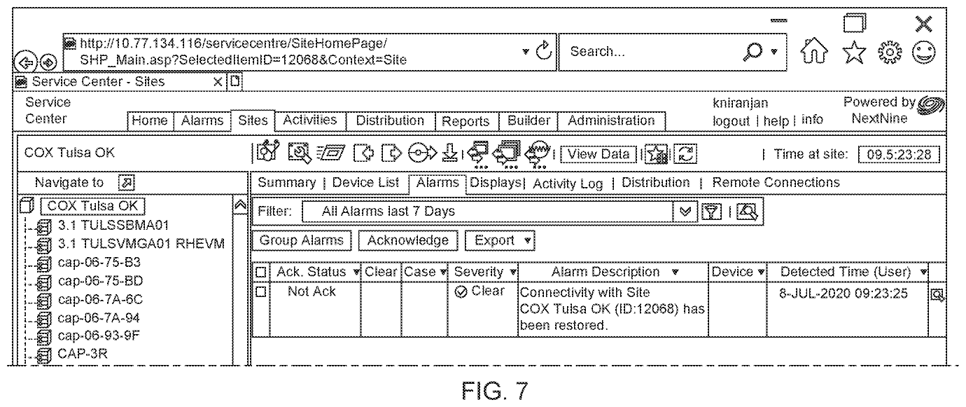

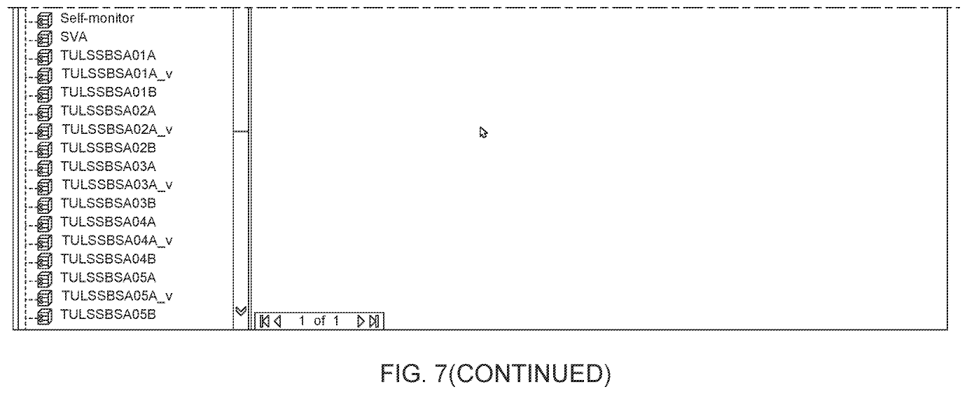

Referring to FIG. 7, by way of example, the management system 120 may identify faults, such as each time a network device loses network connectivity, based upon a search of the network devices using an interface. If desired, the faults may be processed by the mitigation process 430 to attempt an automated mitigation of the fault.

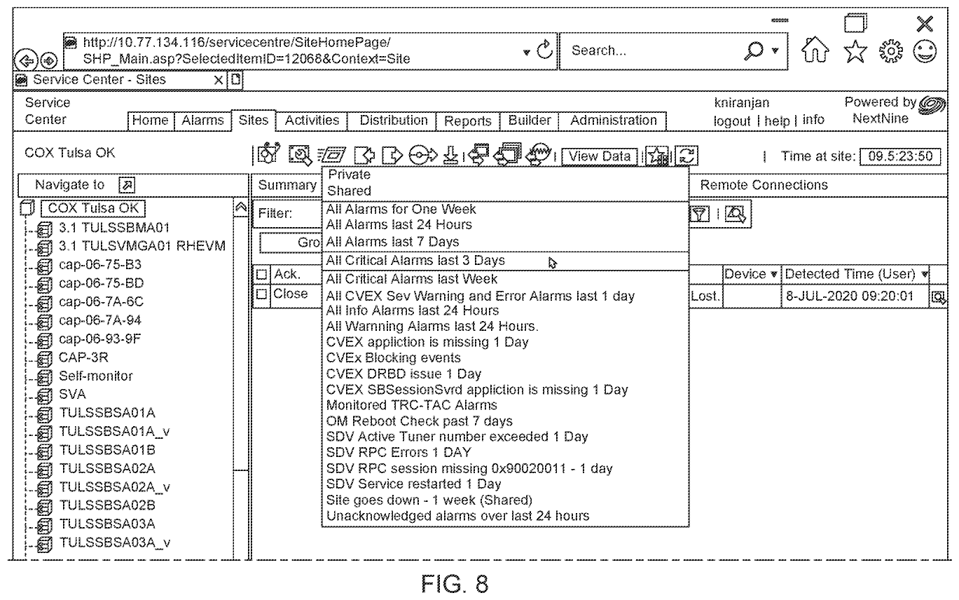

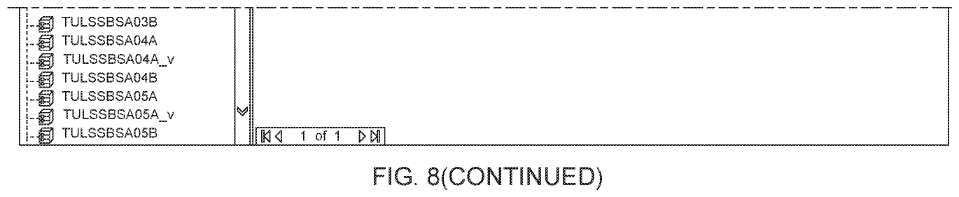

Referring to FIG. 8, by way of example, the management system 120 may identify faults based upon a search criteria, such as each time a network device loses network connectivity based upon the search criteria, based upon a search of the network devices using an interface. If desired, the faults may be processed by the mitigation process 430 to attempt an automated mitigation of the fault.

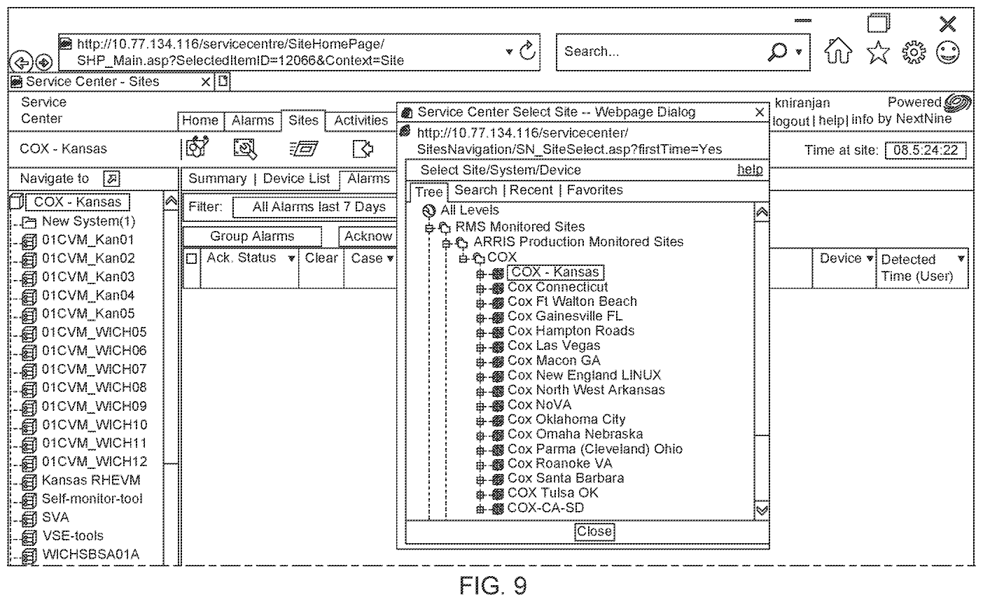

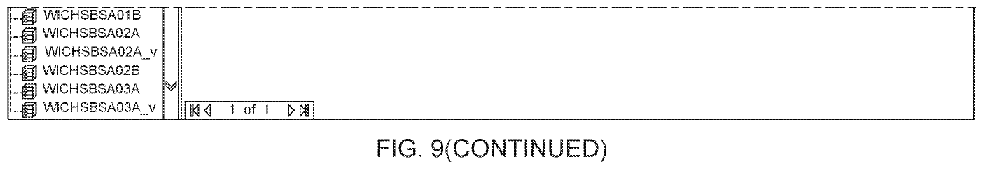

Referring to FIG. 9, by way of example, the management system 120 may identify faults based upon a geographic search criteria, such as each time a network device loses network connectivity based upon the search criteria, based upon a search of the network devices using an interface. If desired, the faults may be processed by the mitigation process 430 to attempt an automated mitigation of the fault.

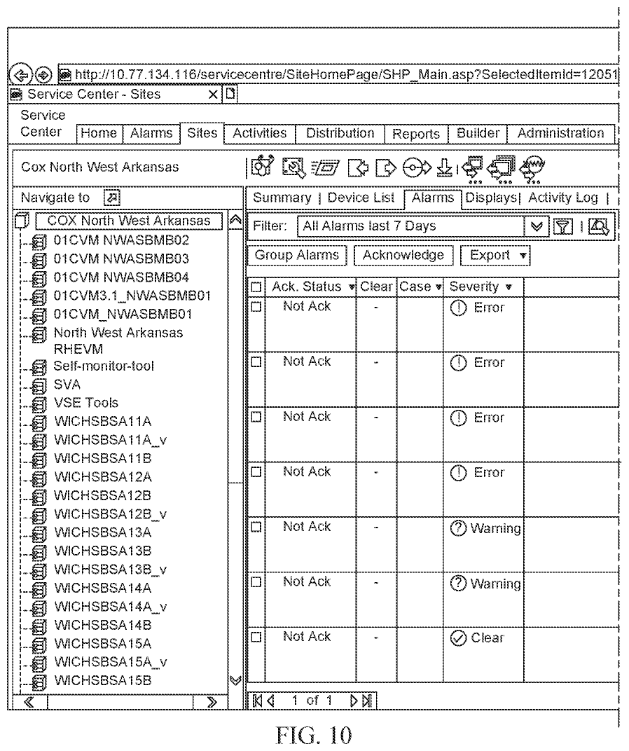

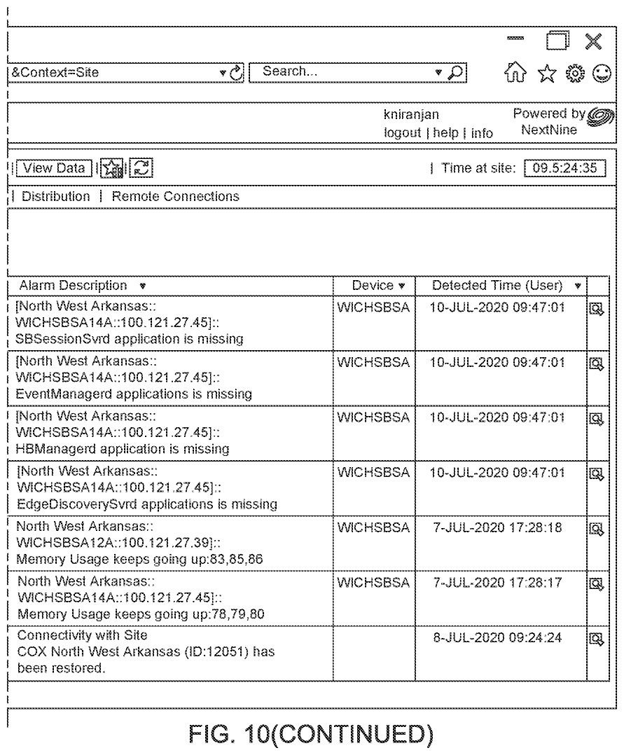

Referring to FIG. 10, by way of example, the monitoring system may identify faults based upon a temporal search criteria, such as each time a network device loses network connectivity based upon the search criteria, based upon a search of the network devices using an interface. If desired, the faults may be processed by the mitigation process 430 to attempt an automated mitigation of the fault. It is noted, that in general, the faults may have several different severities, such as an error or a warning.

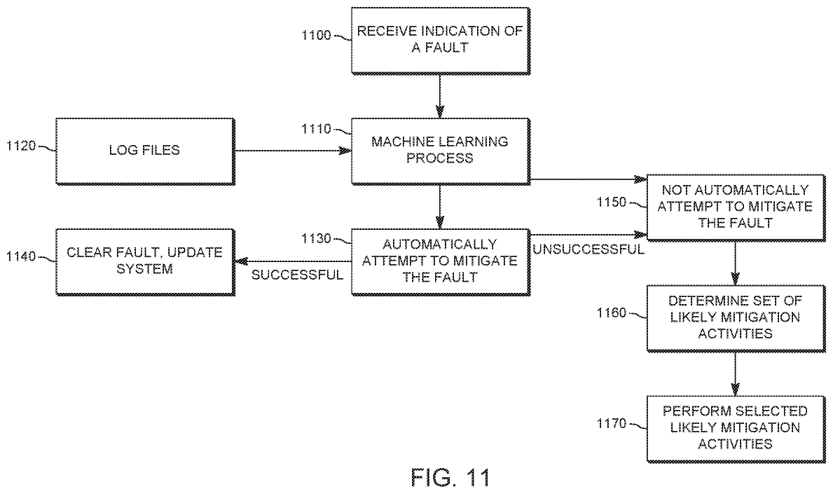

Referring to FIG. 11, the management system 120 may receive an indication of a fault 1100 and based upon an analysis by the machine learning process 1110 based upon log files 1120, the management system may automatically attempt to mitigate the fault 1130. If the fault mitigation is successful, the fault may be cleared and the management system updated to reflect the successful result 1140. In the event that the management system does not automatically attempt to mitigate the fault, the automatic mitigation attempt failed, or otherwise determined not to automatically attempt to mitigate the fault 1150, the management system may determine a set of likely mitigation activities 1160 that may be undertaken to mitigate the fault. The set of likely mitigation activities 1160 may be presented to the support engineer. The support engineer may select one or more of the likely mitigation activities 1160, which may then be automatically performed by the system to attempt to mitigate the fault 1170. In the event that the fault is mitigated, the fault may be cleared and the management system is updated to reflect the successful result. Also, the support engineer may examine the logs and query auxiliary databases of historical information related to mitigation of faults, to determine a set of appropriate actions to attempt to mitigate the fault. Upon successful fault mitigation, the management system is updated to reflect the successful result.

As it may be observed, the management system that includes machine learning to achieve fault mitigation without any manual intervention. As it may be observed, the management system that includes machine learning achieves fault mitigation with manual intervention, with the supplementation of suggested mitigation suggestions.

Referring again to FIG. 4, the identification of faults and the mitigation of the faults, either by an automatic process or a process based in part on the activities of a support engineer, may be provided back to the machine learning process to provide additional training. The additional training of the machine learning process may then be used for the subsequent faults, to provide a more robust system.

In addition to the fault mitigation process, it is desirable to include a post fault mitigation process 450 to verify that the network device and/or software process is likely operating properly. For example, the post fault mitigation process 450 may include verification of the connectivity of the network device with the network, such as by using a “ping”. For example, a post fault mitigation process 450 may include verification of the operation of the network device, such as by sending sample commands to the device and observing the response. Further, if a post fault mitigation process 450 fails, the management system may determine that the fault still exists, and information together with an identification of the fault is provided to a service engineer to further investigate the root cause of the fault.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method for managing network devices interconnected to a communications network comprising:
(a) receiving, by a management system, first log information from a first agent associated with a first said network device interconnected to said communications network;
(b) receiving, by said management system, second log information from a second agent associated with a second said network device interconnected to said communications network;
(c) receiving, by said management system, a first fault from said first agent indicating said first network device has a failure;
(d) after said management system receives said first fault, a machine learning process identifying a first source of said fault based upon said first log information;
(e) after said identifying said first source of said first fault said management system automatically performing a mitigation process to attempt to remedy a cause of said first fault.

2. The method of claim 1 wherein said first agent and said management system are interconnected with one another using a simple network management protocol.

3. The method of claim 2 wherein said first network device is a hardware device.

4. The method of claim 2 wherein said first network device is software.

5. The method of claim 1 wherein said first log information includes variables on said first network device.

6. The method of claim 1 wherein said machine learning process is trained based upon log information from network devices together with fault information.

7. The method of claim 7 wherein said machine learning process is trained based upon courses of action that resulted in repairs of faults.

8. The method of claim 1 wherein said machine learning process is modified based upon said first log information and said first fault.

9. The method of claim 8 wherein said machine learning process is modified based upon a mitigation of said first fault.

10. The method of claim 9 wherein said mitigation of said first fault includes one or more actions that mitigated said first fault.

11. The method of claim 10 wherein said mitigation of said first fault includes one or more actions that failed to mitigate said first fault.
